(19) United States
(12) Patent Application Publication
(10) Pub. No.: US 2026/0276380 A1
(43) Pub. Date: Sep. 17, 2026

(54) SURVEYING LATHS AND METHODS OF MAKING SAME

(71) Applicant: UNITED SURVEYING SUPPLIES, LLC, ROUND ROCK, TX (US)

(72) Inventor: KENNETH C. EURY, II, ROUND ROCK, TX (US)

(73) Assignee: UNITED SURVEYING SUPPLIES, LLC, ROUND ROCK, TX (US)

(21) Appl. No.: 19/076,345

(22) Filed: Mar. 11, 2025

(51) Int. Cl. G01C 15/06; B29C 45/14; B29K 105/16; B33Y 80/00

(52) U.S. Cl. CPC G01C 15/06; B29C 45/14; B29K 2105/16; B29K 2995/0089; B33Y 80/00

(57) ABSTRACT

Surveying laths include a one-piece, three-dimensional, rectilinear or curvilinear, impact-resistant generally plastic body having an outer surface that is markable, the body having a length L, a width W, and a thickness t, where L>W>t, the body having a pointed extremity at a first end and a non-pointed second end. The impact-resistant generally plastic body comprises a major portion of (or all of) one or more impact-resistant polymeric materials and a minor portion (or none) of one or more additives, the impact-resistant polymeric materials selected from the group consisting of polycarbonate (PC), acrylonitrile-butadiene-styrene (ABS), high-density polyethylene (HDPE), polyamide-imide (PAI), high-impact polystyrene (HIPS), and combinations, mixtures and copolymers thereof. The additives, if present, may be natural materials, such as hemp, wood sawdust, and the like. Methods of making the laths are disclosed.

### BACKGROUND INFORMATION

### Technical Field

The present disclosure relates to apparatus and methods in the surveying and construction fields. More particularly, the present disclosure relates to surveying laths.

### Background Art

A surveying lath is a thin, wooden stake, typically made from pine or hardwood, used by surveyors to mark points on the ground during land surveying. It is essentially a flat piece of wood with a pointed end that can be easily driven into the ground or soil, allowing surveyors to write important information like property lines or elevations directly on it. In some instances, laths may be made of essentially hollow plastic materials, such as corrugated plastic, essentially twin walled extruded polypropylene sheet having two flat printable faces with open pipes running through it called flutes.

Key rating metrics of laths, aside from being markable for information purposes, are their sturdiness and safety, especially when a user seeks to pound or otherwise insert the lath into the ground or soil. In both wooden and corrugated plastic versions, stiffness of the material may not be adequate to allow inserting the pointed end into the ground or soil, and in worse cases may break, or even shatter. Wooden laths are selected for use which have no or only very small knots, but during packing for shipment of many laths such as on a pallet, knots can often be missed. The inventor herein is personally aware of instances where wooden laths have shattered, leading to unfortunate eye injuries and other injuries. Corrugated plastic laths, which have many advantages including being recyclable and easy to mark, are rarely strong enough even in thick versions to withstand inserting into the soil, even very loose soils, and are not biodegradable or fire-retardant.

There is a need in the art for laths having significantly longer life than presently available, are safe from splitting or shattering when inserted forcefully into the ground, are easy to mark information upon, and which are or can be modified to be fire-resistant and/or recyclable or otherwise more environmentally friendly. It is my personal and professional experience that surveying companies need laths having these features. Wood laths of different colors, for example, pink for corners, red for fire lanes, and orange for construction are known, but wood laths have the deficiencies mentioned. There is also a need for laths comprising either wholly or partially of natural materials, such as hemp fibers, wood sawdust, and the like.

U.S. Pat. No. 2,773,470 discloses reusable metal surveyor's stakes that can be marked for grade marks and can be easily seen by grader operators, but are complicated in design. So-called “bluetop” (also known as “gradefinder”) stakes are also disclosed that allow a grader blade to pass over without pulling, tilting, or breaking the stake. U.S. Published Patent App. No. 20100107963A1 discloses a marking stake employing corrugated plastic, disclosing the material is easy to mark upon or write upon. U.S. Pat. No. 7,631,447 B2 discloses the existence of both wooden and plastic marking stakes, and introduces a two-piece marking stake having a hard plastic (ABS or other) “ground stake” that is inserted into the ground and which has a central bore for accepting an elastomeric marking post. The presence of the bore makes hammering or other forceful insertion into the ground problematic, and the elastomeric material could not be forced in into the bore using anything but hand force. U.S. Pat. No. 3,638,317 also discloses a two-piece survey rod, the upper piece being a hollow member which attaches to a known wood stake.

As may be seen, current laths may not be adequate for all circumstances, especially for installing and using laths in hard or rocky ground such as found in the Rocky Mountain states of the United States, central and western Texas, and other relatively rocky areas. There remains a need for more robust lath designs. The apparatus and methods of the present disclosure are directed to these needs.

### SUMMARY

In accordance with the present disclosure, improved laths are described, as well as and methods of making the laths, which reduce or overcome many of the faults of previously known laths and methods. In particular, the laths of the present disclosure have been designed to be durable enough to be forced into rocky soils and dry clays using a hammer or other impact tool without shattering, cracking or otherwise breaking.

A first aspect of the disclosure is a lath comprising:
a) a one-piece, three-dimensional, rectilinear or curvilinear, impact-resistant generally plastic body having an outer surface that is markable, the body having a length L, a width W, and a thickness t, where L>W>t, the body having a pointed extremity at a first end and a non-pointed second end;
b) the impact-resistant generally plastic body comprising a major portion of (or all of) one or more impact-resistant polymeric materials and a minor portion (or none) of one or more additives, the impact-resistant polymeric materials selected from the group consisting of polycarbonate (PC), acrylonitrile-butadiene-styrene (ABS), high-density polyethylene (HDPE), polyamide-imide (PAI), high-impact polystyrene (HIPS), and combinations, mixtures and copolymers thereof.

In certain embodiments, the one or more additives may be selected from the group consisting of inorganic and/or organic fibers or particles, flexible sheet materials (fabric or metal), fillers, particulate solids, and the like. Certain embodiments may be additive-free. When an additive is used, coupling agents may be employed to assist bonding of the additive to the impact-resistant polymeric materials.

In certain embodiments the one or more additives may comprise one or more natural elastomers, one or more synthetic elastomers, or combinations and mixtures thereof, for example, but not limited to, natural rubber (NR) otherwise known as isoprene, styrene-butadiene rubber (SBR), butyl rubber (IIR), nitrile rubber (otherwise known as NBR rubber and Buna-N), hydrogenated nitrile (HNBR), neoprene (CR), ethylene propylene diene monomer (EPDM) rubber, fluoroelastomers, and polyurethanes (AU).

In certain embodiments the one or more additives may comprise one or more natural fibers or particles. Examples of natural fibers include materials derived from plants and animals, for example cotton, silk, wool, hemp, jute, abaca, linen, and ramie. Examples of natural particles include sawdust derived from wood, for example hardwoods such as oak, ash, and beech; and softwoods such as cedar, Douglas fir, pine, redwood, spruce, and yew.

In certain embodiments the additive may be a flexible sheet material (metal, fabric, or combination thereof) positioned within the impact-resistant polymeric material. The flexible sheet material may comprise a sheet of metal, fabric, or layered combination thereof, and may have one or more formed slots, round holes, or other shaped through passages therethrough. As used herein the phrase “positioned within” when referring to the flexible sheet material means that the flexible sheet material is molded into or otherwise surrounded by the impact-resistant polymeric material forming the body of the lath.

In certain embodiments the flexible sheet material may be stainless steel sheet. In certain embodiments the stainless steel may be type 304, and in certain embodiments the stainless steel sheet may have a minimum tensile strength of 515 MPa, a minimum yield strength at 0.2% of 205 MPa, a minimum elongation (% in 50 mm) of 40, a maximum Rockwell B hardness of 92, and a maximum Brinell hardness of 201, all in accordance with ASTM A240/A240M.

In certain embodiments the one-piece, three-dimensional, rectilinear or curvilinear, impact-resistant generally plastic body may have a constant width W and thickness t. In certain other embodiments the one-piece, three-dimensional, rectilinear or curvilinear, impact-resistant generally plastic body may have an initial width W and initial thickness t at the second end that are less than those dimensions of the body at a midpoint of the length L of the body. In these embodiments the width W may vary (increase) linearly from the second end to the midpoint of the length L of the body. The width W and thickness t may then remain constant from the midpoint of the body to the pointed first end. The width W of the lath body may be from about 0.625 inch to about 3.5 inches, for example, but not limited to 0.625 inch, or 1 inch, or 1.5 inches, or 2⅜ inches (2.375 inches), or 2⅝ inches (2.625 inches), or 2⅞ inches (2.875 inches), or 3 inches, or 3.5 inches. The length of the lath may range from about 0.5 ft. to about 5 ft., or from about 1 ft. to about 4 ft. In certain embodiments the thickness t may range from about 0.25 inch to about 2 inches, or from about 0.375 inch to about 1.5 inch. The width W and the thickness t will somewhat depend on the choice of impact-resistant polymeric material and additive used, and the amount of room desired for marking on the lath.

In addition to the features already mentioned, lath bodies may consist only of impact-resistant polymeric materials in certain embodiments, but in other embodiments may comprise a combination of impact-resistant polymeric materials and one or more additives such as to prevent failure (shattering or cracking) of the lath upon exposure to impacts. Laths of the present disclosure are engineered to withstand impact forces up to 1,000 Newtons, or up to 1,500 Newtons, or up to 2,000 Newtons, or up to 2,500 Newtons, or up to 3,000 Newtons, or up to 4,000 Newtons or higher, such as may be experienced during lath installation with one or more hammer blows.

Another aspect of the disclosure is a method of making laths of the present disclosure, comprising:
a) providing a mold for forming a one-piece, three-dimensional, rectilinear or curvilinear, impact-resistant generally plastic body having an outer surface that is markable, the body having a length L, a width W, and a thickness t, where L>W>t, the body having a pointed extremity at a first end and a non-pointed second end;
b) selecting an impact-resistant polymer or combination or mixture thereof;
c) selecting one or more flexible sheet materials;
d) positioning the one or more flexible sheet materials within the mold;
e) filling the mold with a molten version of the selected impact-resistant polymer so that the flexible sheet material is surrounded by the molten impact-resistant polymer;
f) cooling the mold and the molten impact-resistant polymer to a temperature sufficient to cause the impact-resistant polymer to form the one-piece, three-dimensional, rectilinear or curvilinear, impact-resistant generally plastic body; and
g) removing the one-piece, three-dimensional, rectilinear or curvilinear, impact-resistant generally plastic body from the mold.

Alternatively, another method of making laths of the present disclosure comprises:
a) providing a mold for forming a one-piece, three-dimensional, rectilinear or curvilinear, impact-resistant generally plastic body having an outer surface that is markable, the body having a length L, a width W, and a thickness t, where L>W>t, the body having a pointed extremity at a first end and a non-pointed second end;
b) selecting an impact-resistant polymer or combination or mixture thereof;
c) selecting one or more additives (fibers, particulate solids, fillers, coupling agents, mixtures and combinations thereof);
d) mixing the one or more additives with a molten version of impact-resistant polymer to form a molten mixture;
e) filling the mold with the molten mixture;
f) cooling the mold and the molten mixture to a temperature sufficient to cause the impact-resistant polymer to form the one-piece, three-dimensional, rectilinear or curvilinear, impact-resistant generally plastic body; and
g) removing the one-piece, three-dimensional, rectilinear or curvilinear, impact-resistant generally plastic body from the mold.

An important feature of the apparatus and methods disclosed herein is the impact-resistant of the generally plastic body of the laths that should allow longer life. Moreover, the laths of the present disclosure may be used without fear of splitting or shattering that is experienced with wooden laths.

These and other features of the apparatus and methods of the disclosure will become more apparent upon review of the brief description of the drawings, the detailed description, and the claims that follow. It should be understood that wherever the term “comprising” is used herein, other embodiments where the term “comprising” is substituted with “consisting essentially of” are explicitly disclosed herein. It should be further understood that wherever the term “comprising” is used herein, other embodiments where the term “comprising” is substituted with “consisting of” are explicitly disclosed herein. Moreover, the use of negative limitations is specifically contemplated; for example, certain laths, lath bodies, and methods may comprise a number of physical components and features but may be devoid of certain optional hardware and/or other features. For example, certain lath embodiments may be devoid of fillers or other particulate materials that may act similarly to knots in wood.

### BRIEF DESCRIPTION OF THE DRAWINGS

The manner in which the objectives of this disclosure and other desirable characteristics can be obtained is explained in the following description and attached drawings in which:

FIGS. 1 and 3 are schematic perspective views of two laths in accordance with the present disclosure;

FIG. 2 is a schematic cross-sectional view of the lath illustrated schematically in FIG. 1, and FIGS. 4, 5, and 6 are schematic cross-sectional views of the lath illustrated schematically in FIG. 3; and

FIGS. 7 and 8 are a logic diagrams of two non-limiting methods of making a lath of the present disclosure.

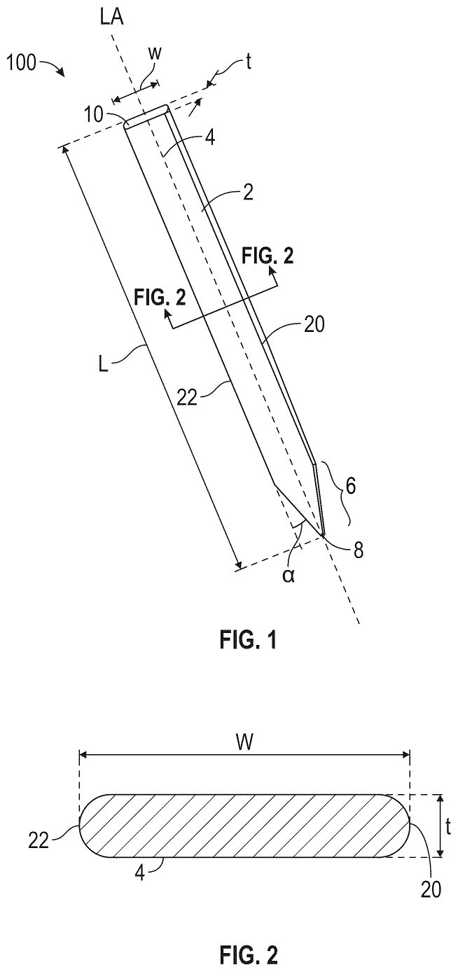

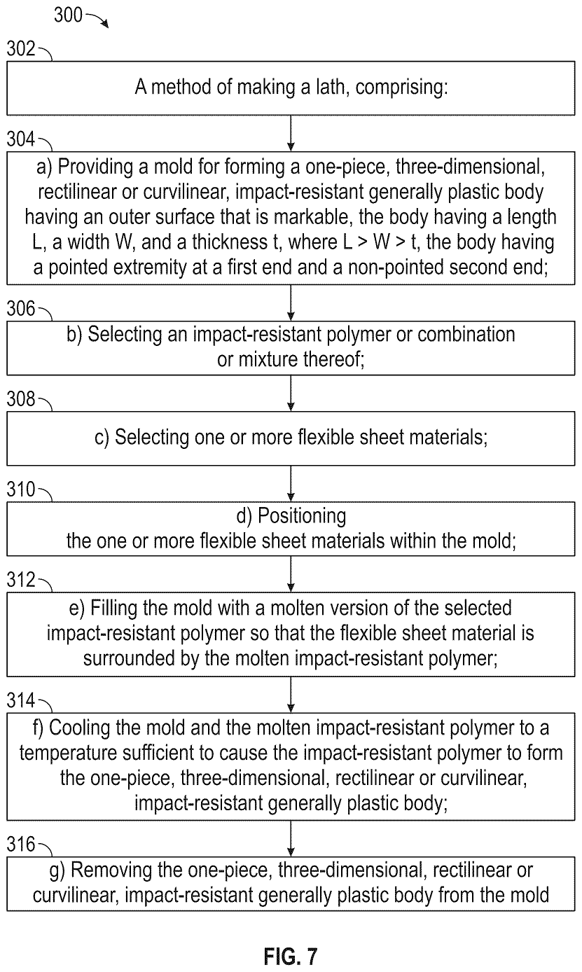

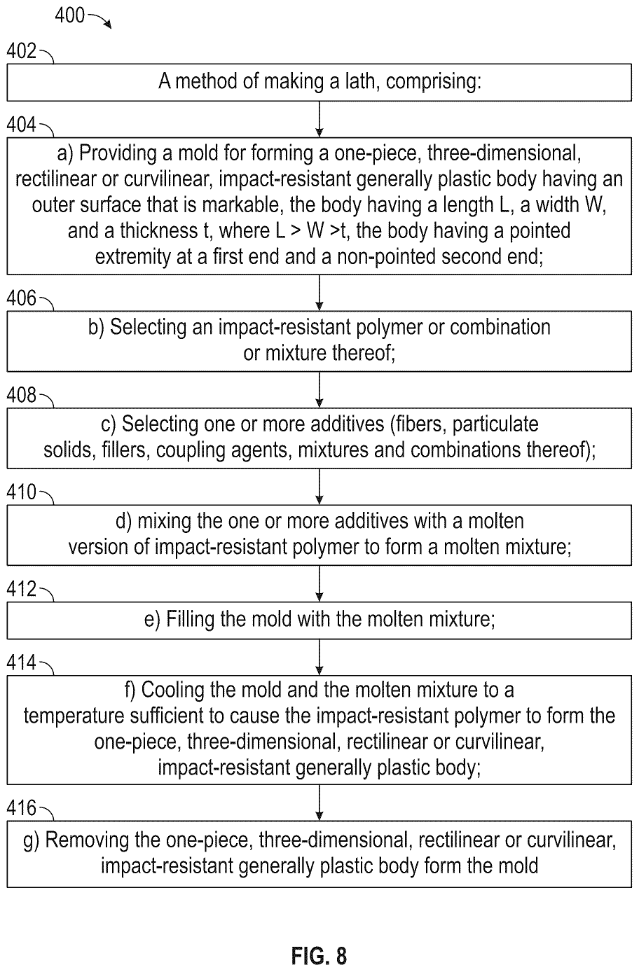

It is to be noted, however, that the appended drawings of FIGS. 1-6 may not be to scale and illustrate only typical apparatus embodiments of this disclosure. Furthermore, FIGS. 7 and 8 illustrate only two of many possible methods of this disclosure. Therefore, the drawing figures are not to be considered limiting in scope, for the disclosure may admit to other equally effective embodiments.

### DETAILED DESCRIPTION

In the following description, numerous details are set forth to provide an understanding of the disclosed apparatus, combinations, and methods. However, it will be understood by those skilled in the art that the apparatus, combinations, and methods disclosed herein may be practiced without these details and that numerous variations or modifications from the described embodiments may be possible. All published patent applications and patents referenced herein are hereby explicitly incorporated herein by reference, irrespective of the page, paragraph, or section in which they are referenced. As used herein, “ASTM” refers to ASTM International, West Conshohocken, Pennsylvania (U.S.A.), formerly known as American Society for Testing Materials.

The primary features of the apparatus, combinations, and methods of the present disclosure will now be described with reference to the drawing figures, after which some of the construction and operational details, some of which are optional, will be further explained. The same reference numerals are used throughout to denote the same items in the figures.

One aspect of the present disclosure are laths. Referring to FIGS. 1 and 2, lath embodiment 100 of the present disclosure comprises a one-piece, three-dimensional, curvilinear, impact-resistant generally plastic body (2) that is unfilled with any additives in embodiment 100. The one-piece, three-dimensional, curvilinear, impact-resistant generally plastic body 2 has an outer markable surface 4. By “markable” I mean that the surface 4 may be marked on by a pencil, ink marker, or the like. The one-piece, three-dimensional, curvilinear, impact-resistant generally plastic body 2 has a point-shaped bottom portion 6 having a pointed first end 8 (pointed extremity) that is driven into the ground or into construction materials, and a non-pointed second end 10. The one-piece, three-dimensional, curvilinear, impact-resistant generally plastic body 2 further includes first and second longitudinal curvilinear edges 20, 22, that are generally parallel with longitudinal axis (LA) of lath 100. The first and second longitudinal curvilinear edges 20, 22 may have a cross-sectional shape that is semicircular (as illustrated schematically in FIG. 2), ovoid, elliptical, or other curvilinear shape.

Still referring to FIGS. 1 and 2, the one-piece, three-dimensional, curvilinear, impact-resistant generally plastic body 2 of lath embodiment 100 has a length (L), a width (W), and a thickness (t), where L>W>t, as well as an α=angle of pointed section 6 of lath 100. Table 1 lists broad and preferred ranges for these dimensions.

TABLE 1
Dimensions for laths

| | Broad range (inches | Less broad range (inches |
|---|---|---|
| | unless otherwise | unless otherwise |
| Feature | specified) | specified) |
| L, length | 0.5 - 5 ft. | 1 - 4 ft. |
| W, width | 0.625 - 3.5 | 1 - 3 |
| t, thickness | 0.25 - 2 | 0.375 - 1.5 |
| α, angle of pointed | 20 - 70 degrees | 30 - 50 degrees |
| section 6 of lath | Measured at 30 degrees | |
| β, angle of upper section | 20 - 70 degrees | 25 - 45 degrees |
| 18 of lath | | |

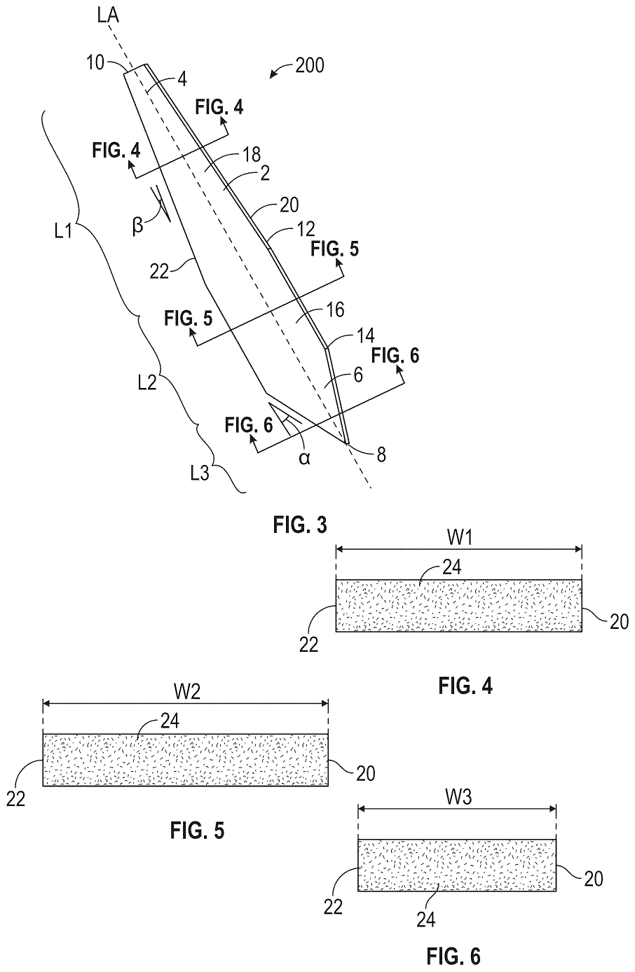

Referring now to FIGS. 3-6, lath embodiment 200 of the present disclosure comprises a one-piece, three-dimensional, rectilinear, impact-resistant generally plastic body 2 that is filled with fiber additives 24. Some possible, non-limiting dimensions of fibers are provided in Table 2. The one-piece, three-dimensional, rectilinear, impact-resistant generally plastic body 2 has an outer markable surface 4, a point-shaped bottom portion 6 having a pointed first end 8 (pointed extremity) that is driven into the ground or into construction materials, and a non-pointed second end 10. The one-piece, three-dimensional, rectilinear, impact-resistant generally plastic body 2 further includes first and second longitudinal rectilinear edges 20, 22, that are generally parallel with longitudinal axis (LA) of lath 200 only in a mid-section 16 of the lath body 2. Mid-section 16 is delineated by an upper transition point 12 and a lower transition point 14. Above mid-section 16 is an upper section 18 of lath body 2 where edges 20, 22 are not parallel to the longitudinal axis LA, but are angled at an angle “3”, values of which are provided in Table 1. The first and second longitudinal rectilinear edges 20, 22 may have a cross-sectional shape that is rectangular (as illustrated schematically in FIGS. 4-6), triangular, tetragonal (including trapezoidal), or other rectilinear shape. As illustrated schematically in FIGS. 3-6, embodiment 200 has a linearly varying (increasing) width W1 from second end 10 to upper transition point 12; a constant width W2 in mid-section 16 (where W1=W2 at transition point 12); and a linearly varying (decreasing) width W3 from lower transition point 14 to pointed extremity 8 (where W2=W3 at lower transition point 14).

In other embodiments considered within this disclosure but not illustrated herein, width W1 and W3 need not change linearly; they could change in step-wise fashion, or could be curved.

TABLE 2
Dimensions for fiber additives

| Feature | Broad range | Less broad range |
|---|---|---|
| D, fiber diameter (mm) | 1 - 25 | 5 - 15 |
| FL, fiber length (cm) | 1 - 20 cm | 5 - 15 cm |
| Crimping (number/cm) | 0 - 25 | 12 - 18 |
| Weight of fibers per | 0.3 - 7 | 0.5 - 3 |
| length (gm/1000 m) | | |

Certain lath embodiments of the present disclosure may feature as an additive a one-piece, flexible sheet insert, which may comprise metal, fabric (for example the aramid fiber based fabric known under the trade designation KEVLAR or similar), or combination thereof positioned within one or more of the upper section 18, the mid-section 16, and the pointed section 6. That is, the impact-resistant polymeric material surrounds the flexible sheet insert. Some examples of metal sheet that may be used include steel, including stainless steels (for example, but not limited to type 304), or steel alloy. The flexible sheet insert may include a plurality of slots in certain embodiments. In certain other embodiments, the flexible sheet insert may include a plurality of through holes. Some embodiments may include both holes and slots. Through holes may be circular or non-circular, and may be arranged in straight pattern or in staggered pattern, or even in diagonal pattern. Non-limiting examples of non-circular through holes are square, triangular, diamond, hexagonal, star; oval, and chevron or heart-shaped.

In certain embodiments the flexible metal sheet insert may have a minimum tensile strength of 515 MPa, a minimum yield strength at 0.2% of 205 MPa, a minimum elongation (% in 50 mm) of 40, a maximum Rockwell B hardness of 92, and a maximum Brinell hardness of 201, all in accordance with ASTM A240/A240M.

FIG. 7 is a logic diagram of one method embodiment 300 of making a lath of the present disclosure (Box 302). A first step of method embodiment 300 comprises providing a mold for forming a one-piece, three-dimensional, rectilinear or curvilinear, impact-resistant generally plastic body having an outer surface that is markable, the body having a length L, a width W, and a thickness t, where L>W>t, the body having a pointed extremity at a first end and a non-pointed second end (Box 304). Method embodiment 300 further comprises, in no particular order, selecting an impact-resistant polymer or combination or mixture thereof (Box 306), and selecting one or more flexible sheet materials (Box 308). Method embodiment 300 further comprises positioning the one or more flexible sheet materials within the mold (Box 310); filling the mold with a molten version of the selected impact-resistant polymer so that the flexible sheet material is surrounded by the molten impact-resistant polymer (Box 312); cooling the mold and the molten impact-resistant polymer to a temperature sufficient to cause the impact-resistant polymer to form the one-piece, three-dimensional, rectilinear or curvilinear, impact-resistant generally plastic body (Box 314); and removing the one-piece, three-dimensional, rectilinear or curvilinear, impact-resistant generally plastic body from the mold (Box 316).

FIG. 8 is a logic diagram of another method embodiment 400 of making a lath of the present disclosure (Box 402). A first step of method embodiment 400 comprises providing a mold for forming a one-piece, three-dimensional, rectilinear or curvilinear, impact-resistant generally plastic body having an outer surface that is markable, the body having a length L, a width W, and a thickness t, where L>W>t, the body having a pointed extremity at a first end and a non-pointed second end (Box 404). Method embodiment 400 further comprises, in no particular order, selecting an impact-resistant polymer or combination or mixture thereof (Box 406) and selecting one or more additives (fibers, particulate solids, fillers, coupling agents, mixtures and combinations thereof)(Box 408). Method embodiment 400 further comprises mixing the one or more additives with a molten version of impact-resistant polymer to form a molten mixture (Box 410); filling the mold with the molten mixture (Box 412); cooling the mold and the molten mixture to a temperature sufficient to cause the impact-resistant polymer to form the one-piece, three-dimensional, rectilinear or curvilinear, impact-resistant generally plastic body (Box 414); and removing the one-piece, three-dimensional, rectilinear or curvilinear, impact-resistant generally plastic body from the mold (Box 416).

Additive methods may also be used to make the laths of the present disclosure, especially when the impact-resistant polymeric materials are devoid of additives or fillers. One such method comprises:
scanning an existing lath or prototype thereof employing a laser scanning or CT scanning device to produce a pointcloud image thereof,
uploading the pointcloud image to a computer having one or more design software loaded thereon and producing a software version of the lath from the pointcloud image;
   uploading the software version of the lath to a 3D printer; and
3D printing the lath with a composition comprising a moldable or printable impact-resistant polymeric material.

Laths of the present disclosure described herein may be made using a variety of additive and/or subtractive processes, including molding, machining, stamping and like additive processes, and/or subtractive processes such as net-shape casting (or near-net shape casting) using rapid prototype (RP) molds. Net-shape or near-net shape casting methods of making a variety of molds for producing a variety of complex products are summarized in patents assigned to 3D Systems, Inc., Rock Hill, South Carolina, U.S.A., for example U.S. Pat. No. 8,285,411. As summarized in the '411 patent, a number of technologies presently exist for the rapid creation of models, prototypes, and objects for limited run manufacturing. These technologies are generally called Solid Freeform Fabrication (“SFF”) techniques. Some SFF techniques include stereolithography, selective deposition modeling, laminated object manufacturing, selective phase area deposition, multi-phase jet solidification, ballistic particle manufacturing, fused deposition modeling, particle deposition, laser sintering, film transfer imaging, and the like. Generally, in SFF, complex parts are produced from a build material in an additive fashion as opposed to conventional fabrication techniques, which are generally subtractive in nature. For example, in most conventional subtractive fabrication techniques material is removed by machining operations or shaped in a die or mold to near net shape and then trimmed. In contrast, additive fabrication techniques incrementally add portions of a build material to targeted locations, layer by layer, in order to build a complex part. SFF technologies typically utilize a computer graphic representation of a part and a supply of a build material to fabricate the part in successive layers. According to the '411 patent, SFF technologies may dramatically shorten the time to develop prototype parts, can produce limited numbers of parts in rapid manufacturing methods, and may eliminate the need for complex tooling and machining associated with conventional subtractive manufacturing methods, including the need to create molds for custom applications. In addition, customized parts can be directly produced from computer graphic data (e.g., computer-aided design (CAD) files) in SFF techniques. Generally, in most techniques of SFF, structures are formed in a layer by layer manner by solidifying or curing successive layers of a build material. For example, in stereolithography a tightly focused beam of energy, typically in the ultraviolet radiation band, is scanned across sequential layers of a liquid photopolymer resin to selectively cure resin of each layer to form a multilayered part. In selective laser sintering, a tightly focused beam of energy, such as a laser beam, is scanned across sequential layers of powder material to selectively sinter or melt powder (such as a metal or ceramic powder) in each layer to form a multilayered part. In selective deposition modeling, a build material is jetted or dropped in discrete droplets, or extruded through a nozzle, such that the build material becomes relatively rigid upon a change in temperature and/or exposure to actinic radiation in order to build up a three-dimensional part in a layerwise fashion. In another technique, film transfer imaging (“FTI”), a film transfers a thin coat of resin to an image plane area where portions of the resin corresponding to the cross-sectional layer of the part are selectively cured with actinic radiation to form one layer of a multilayer part. Certain SFF techniques require the part be suspended from a supporting surface such as a build pad, a platform, or the like using supports that join the part to the supporting surface. Prior art methods for generating supports are described in U.S. Pat. Nos. 5,595,703; 6,558,606; and 6,797,351. The Internet website of Quickparts.com, Inc., Atlanta, GA, a subsidiary of 3D Systems Inc., has more information on some of these techniques and materials that may be used.

In certain embodiments, one or more molding or printing steps may be required to build up the lath to functional length, width, and/or thickness. Also, the methods may include printing steps featuring specific polymers, colors, shapes, software, and the like. 3D printers that may be useful are the 3D printers known under the trade designation Formlabs Form 3B+ and 3BL, available from Formlabs, Millbury, Ohio (USA).

Examples of the impact-resistant polycarbonate (PC) are those having a notched IZOD impact minimum of 90 j/m2 and a maximum of 200 j/m2 (ASTM 3935-21 and 6098-10), and a Rockwell M hardness of at least 70 (ASTM D785). Commercially available PC include those known under the trade designations LEXAN (Sabic), HYZOD (Professional Plastics, Inc., Fullerton, California), TUFFAK (Plaskolite Massachusetts, LLC, Columbus, Ohio) and MAKROLON (Covestro Deutschland AG, Leverkusen, Germany). Unfilled polycarbonate materials are classified into groups according to their composition. The groups are Group 01 (clear) Group 02 (bulletproof), Group 03 (antistatic), Group 04 (mirrored), Group 05 (abrasion-resistant), and Group 06 (colored/tinted). These groups are subdivided into classes which are Class 0, Class 1, Class 2, Class 3, and Class 4 and these classes can be further be subdivided into grades which are Grade 1, Grade 2, Grade 3, Grade 4, Grade 5, Grade 6, Grade 7 and Grade 0. Any of these polycarbonates should work for laths of the present disclosure, provided they meet the impact-resistance desired and are markable.

Examples of the impact-resistant polyamide-imide (PAI) are those having a notched IZOD impact minimum of 100 j/m2 and a maximum of 150 j/m2 (ASTM 3935-21 and 6098-10). Commercially available PAI include those known under the trade designations TORLON, TECAPAI CM XP403 (unreinforced), TECAPAI CM XP440 (unreinforced), TECAPAI CM XP530 (30% glass fiber reinforced), and TECAPAI CM XP730 (30% carbon fiber reinforced) (all available from Ensinger High Performance Plastics). Other commercially available PAI materials are available from Mitsubishi Chemical Advanced Materials (under the trade designation DURATRON) and from Drake Plastics Ltd. Co., Cypress, Texas (under the trade designation DRAKE 4200).

Examples of the impact-resistant acrylonitrile-butadiene-styrene (ABS) are those having a notched IZOD impact minimum of 200 j/m2 and a maximum of 215 j/m2 (ASTM 3935-21 and 6098-10). Commercially available impact-grade ABS include those known under the trade designations TERLURAN (BASF), MAGNUM (Dow Chemical), and CYCOLAC (Sabic).

Examples of the impact-resistant high-density polyethylene (HDPE), are those having a notched IZOD impact minimum of 20 j/m2 and a maximum of 220 j/m2 (ASTM 3935-21 and 6098-10). Commercially available impact-grade HDPE include those known under the trade designations ExxonMobil HDPE HD (ExxonMobil, Spring, Texas); MARLEX HXB TR-512 (Chevron Phillips Chemical (CPChem), The Woodlands, Texas). In particular the latter has a reported tensile strength at yield of 4200 psi (29 MPa) and elongation at break of 800% (ASTM D638, 2 in/min, Type IV bar); flexural modulus of 195,000 psi (1340 MPa)*ASTM D790); a Shore D durometer hardness of 60 (ASTM D2240); and a tensile impact strength of 215 ft-lb/in2 (450 kJ/m2) (ASTM D1822).

Examples of the impact-resistant high-impact polystyrene (HIPS) include those having a notched IZOD impact minimum of 50 j/m2 and a maximum of 350 j/m2 (ASTM 3935-21 and 6098-10). Commercially available impact-grade HIPS include those known under the trade designations HIPS 501S PS (LG Chemical) and TECACOMP PS ELS 1014796 (Ensinger). The latter is a carbon fiber-filled version and has reported density of 1.06 g/cm3; tensile strength of 35 MPa, modulus of elasticity of 7000 MPa, and elongation at break of <1% (DIN EN ISO 527-1, 50 mm/min); a Charpy impact strength of 6.5 kJ/m2 (DIN EN ISO 179-1eU).

Blends, mixtures, layered versions, and coated versions of any of the impact-resistant polymeric materials may be used. Layered versions may include metal layers, or metallized coating layers. Polycarbonate/ABS blends are one example. Polycarbonate coated with anti-scratch material (such as a diamond-like coating) is one example of a coated version.

Examples of suitable additive fibers include glass fibers, polymeric fibers, natural fibers, and combinations and mixtures thereof. Glass fibers (fiberglass) may be E-glass, S-glass, and other known glass compositions. Polymeric fibers may be polyamide fibers, aramid fibers (AR), liquid crystal polymeric fibers, carbon fibers, carbon nanofibers, carbon nanotubes, HDPE fibers, UHDPE fibers, and the like, polyvinyl alcohol fibers, polyester fibers, rayon fibers, acrylic fibers, and/or phenolic fibers. Generally, any ceramic (i.e., glass, crystalline ceramic, glass-ceramic, and combinations thereof) fiber is useful in laths of the present disclosure. An example of a ceramic fibers suitable for laths of the present disclosure are those available from the 3M Company, St. Paul, Minnesota under the trade designation NEXTEL. Glass fibers may be used, at least because they impart desirable characteristics to the articles and are relatively inexpensive. Fibers may have random or non-random lengths, diameters, composition, and may be twisted or non-twisted, crimped or non-crimped. Examples of natural fibers include materials derived from plants and animals, for example cotton, silk, wool, hemp, jute, abaca, linen, and ramie, and combinations and mixtures of any of these. Examples of natural particles include sawdust derived from wood, for example hardwoods such as oak, ash, and beech; and softwoods such as cedar, Douglas fir, pine, redwood, spruce, and yew, and combinations and mixtures of any of these. Combinations and mixtures of glass fibers, polymeric fibers, and natural fibers are suitable as well, for example, but not limited to: 50 percent hemp fibers with 50 percent cedar fibers; 50 percent hemp fibers with 25 percent cedar fibers and 25 percent oak fibers, and the like.

Sawdust or wood shaving is a by-product of wood, obtained from various woodworking operations, for instance, sawing, planing, sanding, and milling of wood. It is a relatively abundant, cheap, and lignocellulosic compound, which may be found in large quantities and has disposal problems.

Hemp stalks are harvested for their fibers, which are used to manufacture hundreds of products, including rope, paper, construction materials, carpeting, textiles, insulation, animal bedding and bioplastics. There are two main types of fibers within the plant, the bast and the hurd, and each has different qualities and uses. Bast fibers are the long fibers typically used to make products such as rope and paper, while hurd fibers are shorter and derived from the pithy inner material and is used in absorbent products for spills and animal bedding.

When an additive, such as fibers, particulates, nanomaterials, and other additives are used in a polymeric matrix to improve properties, it is common to use suitable interfacial binding agents to enhance adhesion of glass fibers to thermoplastic materials, such as a silane coupling agent, to improve the adhesion to the thermoplastic material. Examples of silane coupling agents include those available under the trade designations “Z-6020” and “Z-6040,” from Dow Corning Corp., Midland, MI.

From the foregoing detailed description of specific embodiments, it should be apparent that patentable laths and methods have been described. Although specific embodiments of the present disclosure have been described herein in some detail, this has been done solely for the purposes of describing various features and aspects of the laths and methods, and is not intended to be limiting with respect to their scope. It is contemplated that various substitutions, alterations, and/or modifications, including but not limited to those implementation variations which may have been suggested herein, may be made to the described embodiments without departing from the scope of the appended claims.

What is claimed is:

1. A lath comprising:
a) a one-piece, three-dimensional, rectilinear or curvilinear, impact-resistant generally plastic body having an outer surface that is markable, the body having a length L, a width W, and a thickness t, where L>W>t, the body having a pointed extremity at a first end and a non-pointed second end;
b) the impact-resistant generally plastic body comprising a major portion of one or more impact-resistant polymeric materials and a minor portion of one or more additives, the impact-resistant polymeric materials selected from the group consisting of polycarbonate (PC), acrylonitrile-butadiene-styrene (ABS), high-density polyethylene (HDPE), polyamide-imide (PAI), high-impact polystyrene (HIPS), and combinations, mixtures and copolymers thereof.

2. The lath of claim 1, wherein the one or more additives is selected from elastomers, fibers, flexible sheet materials, coupling agents, fillers, particulate solids, and combinations and mixtures thereof.

3. The lath of claim 1, wherein the one or more additives is selected from one or more natural elastomers, one or more synthetic elastomers, and combinations and mixtures thereof.

4. The lath of claim 2 wherein the elastomers are selected from the group consisting of natural rubber (NR) otherwise known as isoprene, styrene-butadiene rubber (SBR), butyl rubber (IIR), nitrile rubber (otherwise known as NBR rubber and Buna-N), hydrogenated nitrile (HNBR), neoprene (CR), ethylene-propylene-diene monomer (EPDM) rubber, fluoroelastomers, polyurethanes (AU), and mixtures and combinations thereof.

5. The lath of claim 1, wherein the one or more additives is a flexible sheet material positioned within the impact-resistant polymeric material.

6. The lath of claim 5, wherein the flexible sheet material is selected from metal, fabric, and combinations thereof.

7. The lath of claim 6, wherein the flexible sheet material comprises a layered combination of metal sheets and fabric sheets.

8. The lath of claim 1, wherein the one-piece, three-dimensional, rectilinear or curvilinear, impact-resistant generally plastic body has a constant width W and thickness t.

9. The lath of claim 1, wherein the one-piece, three-dimensional, rectilinear or curvilinear, impact-resistant generally plastic body has an initial width W and initial thickness t at the second end that are less than those dimensions of the body at a midpoint of the length L of the body.

10. The lath of claim 1, wherein the one-piece, three-dimensional, rectilinear or curvilinear, impact-resistant generally plastic body width W increases linearly from the second end to the midpoint of the length L of the body, the width W and thickness t then remaining constant from the midpoint of the body to the pointed first end.

11. The lath of claim 1, wherein the width W ranges from about 1 inch to about 3 inches.

12. The lath of claim 1, wherein the length L ranges from about 1 ft. to about 4 ft.

13. The lath of claim 1, wherein the thickness t ranges from about 0.375 inch to about 1.5 inch.

14. The lath of claim 1, wherein the lath body comprises a combination of impact-resistant polymeric materials and one or more additives such as to prevent failure shattering or cracking of the lath upon exposure to impacts up to 1,000 Newtons.

15. A method of making a lath, comprising:
a) providing a mold for forming a one-piece, three-dimensional, rectilinear or curvilinear, impact-resistant generally plastic body having an outer surface that is markable, the body having a length L, a width W, and a thickness t, where L>W>t, the body having a pointed extremity at a first end and a non-pointed second end;
b) selecting an impact-resistant polymer or combination or mixture thereof;
c) selecting one or more flexible sheet materials;
d) positioning the one or more flexible sheet materials within the mold;
e) filling the mold with a molten version of the selected impact-resistant polymer so that the flexible sheet material is surrounded by the molten impact-resistant polymer;
f) cooling the mold and the molten impact-resistant polymer to a temperature sufficient to cause the impact-resistant polymer to form the one-piece, three-dimensional, rectilinear or curvilinear, impact-resistant generally plastic body; and
g) removing the one-piece, three-dimensional, rectilinear or curvilinear, impact-resistant generally plastic body from the mold.

16. The method of claim 15 wherein the impact-resistant polymer is selected from the group consisting of polycarbonate (PC), acrylonitrile-butadiene-styrene (ABS), high-density polyethylene (HDPE), polyamide-imide (PAI), high-impact polystyrene (HIPS), and combinations, mixtures and copolymers thereof.

17. The method of claim 15 wherein the one or more flexible sheet materials is stainless steel sheet having a minimum tensile strength of 515 MPa, a minimum yield strength at 0.2% of 205 MPa, a minimum elongation (% in 50 mm) of 40, a maximum Rockwell B hardness of 92, and a maximum Brinell hardness of 201, all in accordance with ASTM A240/A240M.

18. A method of making laths, comprising:
a) providing a mold for forming a one-piece, three-dimensional, rectilinear or curvilinear, impact-resistant generally plastic body having an outer surface that is markable, the body having a length L, a width W, and a thickness t, where L>W>t, the body having a pointed extremity at a first end and a non-pointed second end;
b) selecting an impact-resistant polymer or combination or mixture thereof;
c) selecting one or more additives;
d) mixing the one or more additives with a molten version of impact-resistant polymer to form a molten mixture;
e) filling the mold with the molten mixture;
f) cooling the mold and the molten mixture to a temperature sufficient to cause the impact-resistant polymer to form the one-piece, three-dimensional, rectilinear or curvilinear, impact-resistant generally plastic body; and
g) removing the one-piece, three-dimensional, rectilinear or curvilinear, impact-resistant generally plastic body from the mold.

19. The method of claim 18 wherein the impact-resistant polymer is selected from the group consisting of polycarbonate (PC), acrylonitrile-butadiene-styrene (ABS), high-density polyethylene (HDPE), polyamide-imide (PAI), high-impact polystyrene (HIPS), and combinations, mixtures and copolymers thereof.

20. The method of claim 18 wherein the one or more additives are selected from fibers, particulate solids, fillers, coupling agents, mixtures and combinations thereof.
